(19) United States
(12) Patent Application Publication
(10) Pub. No.: US 2013/0033229 A1
(43) Pub. Date: Feb. 7, 2013

(54) METHOD AND SYSTEM TO ELECTRICALLY CHARGE AND DISCHARGE A BATTERY USING AN ELECTRICAL CHARGING SYSTEM THAT ELECTRICALLY COMMUNICATES WITH A REGENERATIVE BRAKING ELECTRICAL CIRCUIT

(71) Applicants: Richard J. Boyer, Mantua, OH (US); Brian D. Pasha, Cortland, OH (US); John Victor Fuzo, Cortland, OH (US)

(72) Inventors: Richard J. Boyer, Mantua, OH (US); Brian D. Pasha, Cortland, OH (US); John Victor Fuzo, Cortland, OH (US)

(73) Assignee: DELPHI TECHNOLOGIES, INC., Troy, MI (US)

(21) Appl. No.: 13/562,954

(22) Filed: Jul. 31, 2012

Related U.S. Application Data
(60) Provisional application No. 61/515,866, filed on Aug. 6, 2011.

(51) Int. Cl. H02J 7/00

(52) U.S. Cl. 320/109; 320/138

(57) ABSTRACT

A method to electrically charge an energy storage device (ESD) includes a step of electrically charging the ESD with energy transmitted through a regenerative braking electrical circuit (RBEC) disposed on vehicle by an electrical charging system (ECS) in electrical connection therewith. The ESD may be electrically charged by the ECS or a motor/generator that is also in electrical communication with the RBEC. The method also includes another step of electrically transmitting energy from the ESD through the RBEC and the ECS to supply energy to a power grid disposed external to the vehicle. An ECS for electrically charging an ESD is also presented that includes a first transducer, a second transducer that wirelessly receives energy from the first transducer, a motor/generator, and at least one electrical component which receives energy from the second transducer or energy from the motor/generator to electrically charge the ESD.

### RELATED DOCUMENTS

This application claims priority to provisional application U.S. Ser. No. 61/515,866 filed on 6 Aug. 2011.

### TECHNICAL FIELD

This invention relates to an electrical charging system (ECS) used to electrically charge and discharge an energy storage device (ESD), more particularly, an ECS electrically interfaces with a regenerative braking electrical circuit (RBEC) disposed in a vehicle to electrically charge and/or discharge the ESD.

### BACKGROUND OF INVENTION

It is known to electrically charge an energy storage device (ESD), or battery disposed on a hybrid vehicle or hybrid electric vehicle.

Consumers may desire a charging system that electrically charges a battery of a vehicle without the need to plug the vehicle into a power source. One such charging system, U.S. Ser. No. 13/450,881 (Delphi Docket Number DP-319929) filed on Apr. 19, 2012, describes a high power electrical charging system (ECS) that electrically charges an energy storage device (ESD) disposed on a vehicle. This high power ECS includes an electrical signal shaping device (ESSD) that electrically shapes and transmits electrical current received from a second transducer of the ECS to subsequently electrically charge the ESD disposed on the vehicle. The high power ECS includes a first transducer that wirelessly transmits magnetic energy to the second transducer. While this ECS works well to electrically charge the ESD, it does not also allow the ESD to also electrically provide the ESD's stored energy to an electrical device disposed external to the vehicle, such as to an energy power grid, for example, so that this stored energy may be utilized when needed.

Thus, what is needed is an ECS that robustly electrically charges an ESD that is also operative to assist the ESD to provide the ESD's energy back to a power grid disposed external to the vehicle.

### SUMMARY OF THE INVENTION

In accordance with one embodiment of the invention, a method to electrically charge an energy storage device (ESD) is presented. The single step in the method includes electrically charging the ESD with energy transmitted through at least one electrical component in electrical communication therewith. The ESD is electrically charged by the ECS or at least one motor/generator. The ECS and the at least one motor/generator are in respective electrical communication with the at least one electrical component. The method further includes a step of electrically transmitting at least electrical current from the ESD through at least one electrical component and the ECS to the at least one electrical device.

In another embodiment of the invention, the at least one electrical component is a regenerative braking electrical circuit disposed in a vehicle and the at least one electrical device is a power gird disposed external to the vehicle.

In accordance with yet another embodiment of the invention, an electrical charging system (ECS) for electrically charging an energy storage device (ESD) disposed on a vehicle includes a first transducer and a second transducer. The first transducer is configured to receive energy from a power source. The second transducer is configured to receive at least a portion of the received energy wirelessly transmitted from the first transducer. The ECS further includes at least one motor/generator that is configured to capture kinetic energy from at least one wheel of the vehicle. The at least one electrical component receives energy from the second transducer or kinetic energy from the at least one motor/generator to electrically charge the ESD.

Further features, uses and advantages of the invention will appear more clearly on a reading of the following detailed description of the embodiments of the invention, which are given by way of non-limiting example only and with reference to the accompanying drawings.

### BRIEF DESCRIPTION OF THE DRAWINGS

This invention will be further described with reference to the accompanying drawings in which:

FIG. 1 is a block diagram view of an electrical charging system (ECS) that includes an off-vehicle transducer and an on-vehicle transducer in an energy coupling arrangement that is used to supply energy to a mobile power system, in accordance with the invention;

FIG. 2 shows a more detailed block diagram of the ECS of FIG. 1 that includes the on-vehicle transducer being in electrical communication with a regenerative braking electrical circuit (RBEC) to electrically charge an energy storage device (ESD) disposed on a vehicle when the ECS operates in a first mode of operation;

FIG. 3 shows a side view of a vehicle and disposition of elements of the ECS of FIG. 2 in relation therewith;

FIG. 4 shows the ECS of FIG. 2 operating in a second mode of operation that includes the movement of electrical current supplied from the ESD through the RBEC and the ECS to a power grid disposed external to the vehicle;

FIG. 5 shows a magnified view of the RBEC and block diagram details thereof;

FIG. 6 shows an operation truth table for the ECS of FIG. 2; and

FIG. 7 shows a method to electrically charge an ESD of FIG. 2 and electrically transmit current from the ESD of FIG. 4 to supply energy to the power grid.

### DETAILED DESCRIPTION OF THE EMBODIMENTS

As energy becomes more costly to generate and use, it may be desired that energy be generated and stored when the demand and cost for energy is low and effectively retrieved for use when demand and the cost for the stored energy is high. In a vehicle application, an energy storage device (ESD), or battery of a hybrid vehicle or a hybrid electric vehicle may be utilized for just such an energy storage medium and so utilized for just such a purpose. For instance, the battery of the vehicle may be electrically charged during the nighttime hours when energy rates are low and, if the vehicle is not being used for its normal intended purpose of driving a human occupant to a destination, may be used to provide energy from the stored battery and for use in an energy power grid when demand for the energy is high during daytime hours. In this scenario, an owner of the electrical charging system may be able to advantageously commercially monetize this energy sharing arrangement in conjunction with using the battery to power the drivetrain of the vehicle.

A regenerative braking system is typically used in a hybrid vehicle or a hybrid electrical vehicle. The regenerative braking system powers the drivetrain to the vehicle's wheels when the vehicle is in motion by a motor portion of a motor/generator. The regenerative braking system also serves to electrically charge the vehicle's battery when the vehicle is being braked to slow down the vehicle's movement with the generator portion of the motor/generator. In this manner, then, the regenerative braking system acts as a bidirectional switch. It has been discovered that re-using this bidirectional switch functionality of the regenerative braking system advantageously enhances the usefulness and usability of an electrical charging system (ECS). First, the ECS may further use the regenerative braking electronics to electrically interface with, and assist in electrically charging the battery. Second, the ECS may also assist to provide the battery's stored energy to a power grid with the stored energy being moved, or transmitted from the vehicle's battery through both the regenerative braking electronics and the ECS prior to reaching the power grid.

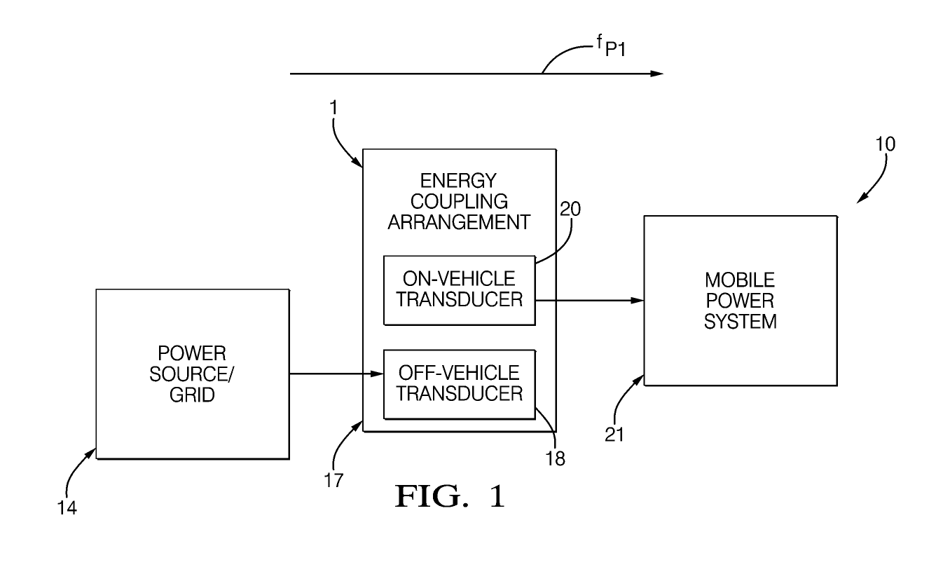

Thus, referring to FIGS. 1-6 and in accordance with this discovery and in one embodiment of this invention, an ECS 10 electrically charges an energy storage device (ESD) 12 and also assists to provide the ESD's stored energy back to an energy power grid 14. ESD 12 is disposed in a vehicle 16 which may be a hybrid vehicle or an electric vehicle. ECS 10 includes a first, or off-vehicle transducer 18, a second, or on-vehicle transducer 20, at least one AC motor/generator 22a, 22b, and at least one electrical component 24. Off-vehicle transducer 18 and on-vehicle transducer 20 form an energy coupling arrangement 17. Off-vehicle transducer 18 is spaced a distance apart from on-vehicle transducer 20. Referring to FIG. 1, arrangement 17 supplies energy to a mobile power system 21 that includes vehicle 16. At least one electrical component 24 is in electrical communication with second transducer 20 and at least one AC motor/generator 22a, 22b. At least one electrical component 24 is a regenerative braking system that includes one or more regenerative braking electrical circuits (RBEC) 26. RBEC 26 is disposed in vehicle 16 and is also in electrical communication with ESD 12. Both ECS 10 and RBEC 26 are formed from any number of electrical components/elements arranged together that include resistors, capacitors, inductors, diodes, relays, and the like.

ESC 10 advantageously electrically charges ESD 12 through RBEC 26 when ECS 10 is disposed in a first mode of operation 1 when vehicle 16 is in a rest state. ECS 10 advantageously assists to provide at least electrical current supplied from the ESD's stored energy when ECS 10 is in a second mode of operation 2 which is different from first mode of operation 1. Second mode of operation 2 also occurs when vehicle 16 is in a rest state. In contrast to the first and the second mode of operation of ECS 10 being operative when the vehicle is in a rest state, a third mode of operation electrically charges ESD 12 when the vehicle is in motion. The third mode of operation to electrically charge ESD 12 includes a generator portion of AC motor/generator 22a, 22b electrically charging ESD 12 when vehicle 16 is in movement and also being braked by a human operator, or driver 34 of vehicle 16 to slow the vehicle's speed down. Alternately, the owner of the ECS may be a human operator other than the driver of the vehicle. The third mode of operation to electrically charge ESD 12 is associated with a conventional regenerative braking system that operates based on functionality as is known in the regenerative braking art. A rest state of vehicle 16 is defined as vehicle 16 not being in movement, or lacking movement, or being stopped. In one alternate embodiment, the rest state is associated with the vehicle's drivetrain being disposed in a PARK position. In contrast, for example, a vehicle having movement is one that is movingly traveling down a road. A more detailed discussion of the first and the second mode of operation of the ECS and the third mode of operation to electrically charge the EDS when the vehicle is in motion is further described as follows.

First Mode of Operation of ECS

As previously described herein, ESC 10 electrically charges ESD 12 through RBEC 26 when ECS 10 is disposed in a first mode of operation 1 when vehicle 16 is in a rest state. When ECS 10 in first mode of operation 1, off-vehicle transducer 18 receives energy from a power source associated with power grid, or power source/grid 14 via a power transmitter 15. For example, the power source/grid may supply 120 VAC or 240 VAC to the off-vehicle transducer. Alternately, any amount of voltage and current may be supplied to the off-vehicle transducer and operate the ECS. Power source/grid 14 is best illustrated in FIGS. 1, 2, and 4. Power transmitter 15 includes a power convertor electrical circuit 19. Power convertor electrical circuit 19 is effective to allow bi-directional signal transfer that will soon be appreciated with a further understanding of first and second mode of operation 1, 2 of ECS 10. Power is supplied from power source/grid 14 through power convertor 19 to first transducer 18 carried on an electrical signal path 41. The power transmitter and the power convertor are formed from similar electrical components that are used to form ECS 10 and RBEC 26 as previously described herein.

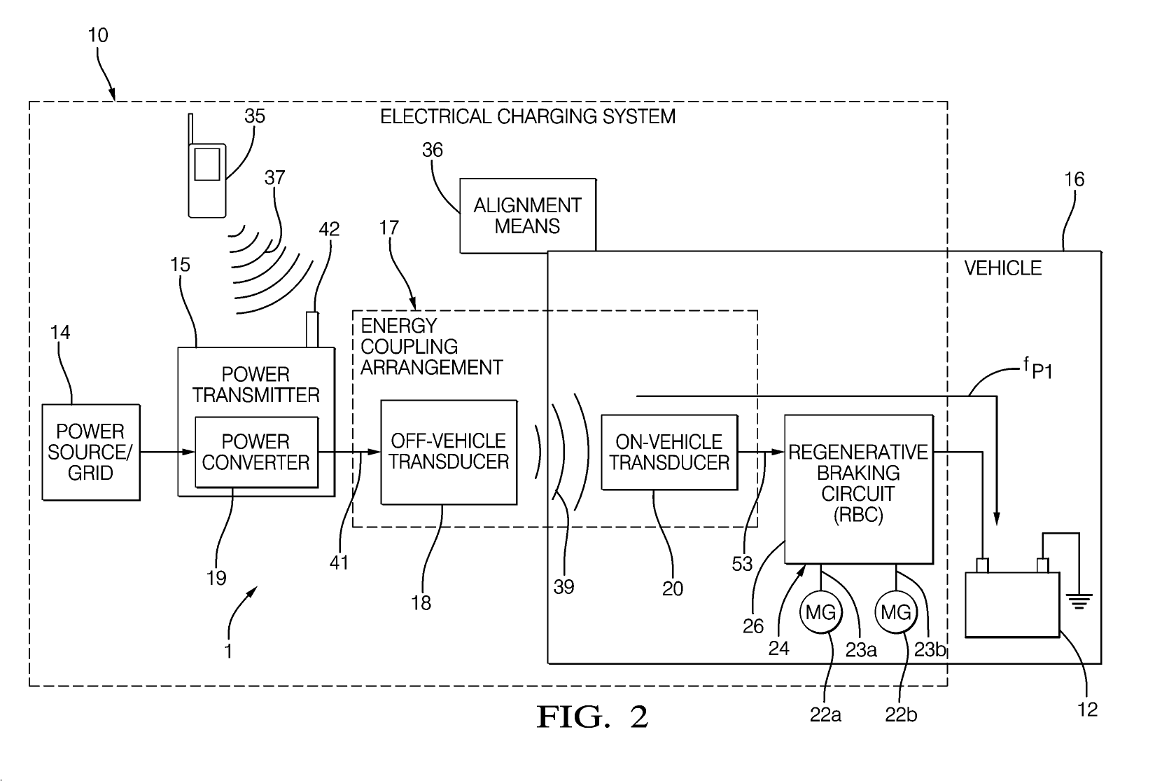

The electrical signal paths as described herein may include electrical signals being carried on wire conductors or printed circuit board trace disposed on printed circuit boards (PCB), and the like, and is commonly known in the electrical arts. When second transducer 20 is disposed proximate to first transducer 18 such that energy is wirelessly transmitted across the distance between transducers 18, 20, second transducer 20 is configured to receive at least a portion of the energy wirelessly transmitted from first transducer 18. This wireless energy transfer is depicted by reference numeral 39, as best illustrated in FIG. 2. Preferably, this wireless energy transfer is magnetic or electromagnetic energy. Alternately, the energy transfer may be inductive energy. Second transducer 20 is disposed on vehicle 16 and first transducer 18 and power source/grid 14, respectively, are disposed external to vehicle 16. RBEC 26 receives energy from second transducer 20 from an electrical signal carried on a signal path 53. Thus, in first mode of operation 1 ECS 10 electrically charges ESD 12 through ESC 10 and RBEC 26 so that electrical current flows through ECS 10 and RBEC 26 in a flow path direction fp₁, as best illustrated in FIGS. 1 and 2. In relation to flow path direction fp₁, RBEC 26 is in downstream electrical communication from on-vehicle transducer 20. ESC 10 as described herein is in contrast to other embodiments of a high power ECS as described in U.S. Ser. No. 13/450,881, filed on Apr. 19, 2012 entitled “ELECTRICAL CHARGING SYSTEM HAVING ENERGY COUPLING ARRANGEMENT FOR WIRELESS ENERGY TRANSMISSION THEREBETWEEN,” which is incorporated by reference herein in its entirety.

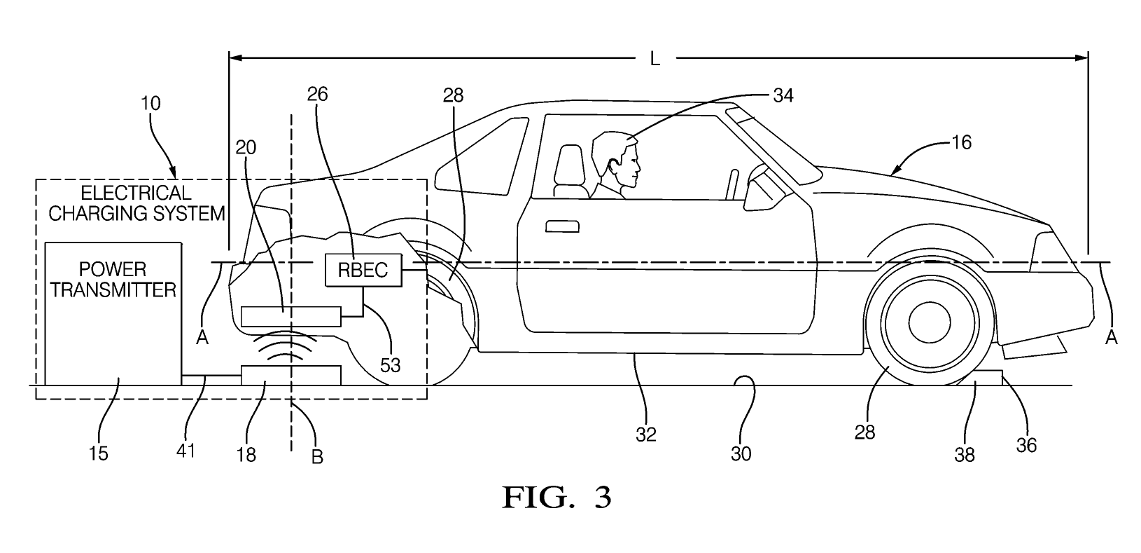

Referring now to FIG. 3, a side view of vehicle 16 is illustrated in which various elements such as ECS 10 and RBEC 26 are relationally depicted thereon. Vehicle 16 has length L and is disposed along an longitudinal axis A. Vehicle 16 includes wheels 28 being disposed on a generally planar ground surface 30 that are connected with a drivetrain (not shown) of vehicle 16. On-vehicle transducer 20 is disposed on a support structure (not shown) of vehicle 16 along an undercarriage 32 of vehicle 16. Vehicle 16 is movingly positioned by a human operator 34 of vehicle 16 so that on-vehicle transducer 20 is aligned to substantially overlie off-vehicle transducer 18 along longitudinal axis B which is generally transverse to axis A. Such a situation may occur when the ESD is at a low state of electrical charge and needs to be electrically recharged. Alternately, human operator 34 may also be the operator of ECS 10. In another alternate embodiment, only a portion of the on-vehicle transducer may overlie the off-vehicle transducer so that the ECS still effectively operates to electrically charge the ESD through the RBEC. Still alternately, the on-vehicle transducer may not overlie the off-vehicle transducer and the ECS still be effective to electrically charge the ESD through the RBEC. In yet another alternate embodiment, the on-vehicle transducer may reside along any portion of the undercarriage along length L of the vehicle. In a further alternate embodiment, the on-vehicle transducer may reside on the vehicle but not also be disposed on, or adjacent to the undercarriage of the vehicle. An alignment means 36, such as a wheel chock 38 for example, may further assist human operator 34 to movingly position vehicle 16 so transducers 18, 20 are in alignment in a manner so that ECS 10 may effectively electrically charge ESD 14 through RBEC 26.

Second Mode of Operation of ECS

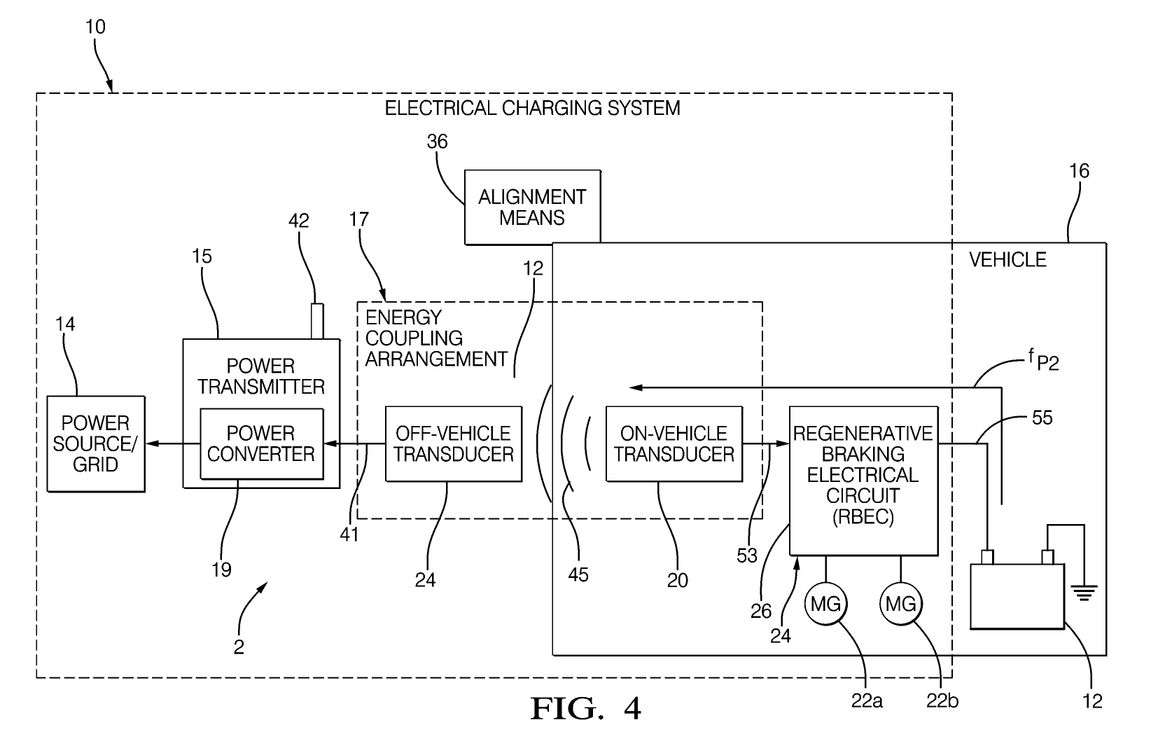

Referring to FIG. 4, ECS 10 advantageously assists to provide at least electrical current supplied from the ESD's stored energy when ECS 10 is in a second mode of operation 2, as has been previously described herein. This stored energy of ESD 12, which may include at least an electrical current, is transmitted through RBEC 26 and then subsequently from on-vehicle transducer 20 to off-vehicle transducer 18 of ECS 10 in a flow path direction fp₂ that is in an opposite direction to flow path direction fp₁. Lastly, the energy is transmitted through power convertor 19 of power transmitter 15 and to the power grid as depicted by power source/grid 14. As depicted by reference numeral 45, the wireless transmission between transducers 18, 20 is in an opposite direction to wireless transmission 39 when ECS 10 is in first mode of operation 1. Thus, when ECS 10 is in second mode of operation 2, ECS is not in first mode of operation 1. In this fashion, ECS 10 at least provides an electrical current representative of the stored energy of ESD 14 to power grid 14 disposed external to vehicle 16.

Third Mode of Operation to Electrically Charge ESD

At least one AC motor/generator 22a, 22b is configured to capture kinetic energy from at least one wheel, or tire 28 of vehicle 16 when vehicle 16 is in movement, such as been previously described herein. At least a portion of the kinetic energy captured by at least one AC motor/generator 22a, 22b generated by at least one wheel 28 during movement of vehicle 16 produces a corresponding electrical signal that is carried on signal paths 23a, 23b and further electrically transmitted through RBEC 26 so that ESD 12 is electrically charged during braking of vehicle 16.

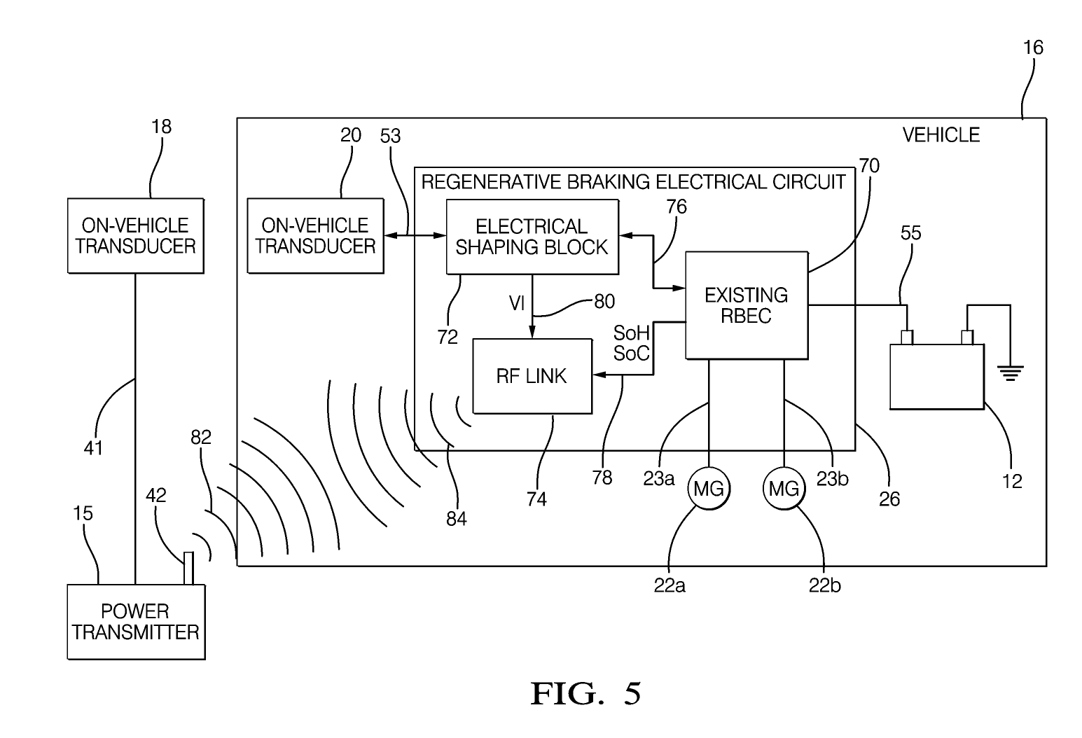

Referring to FIG. 5, a magnified view of RBEC 26 is illustrated. RBEC 26 includes an existing regenerative braking electrical circuit block (ERBEC) 70, an electrical shaping block 72, and a RF link block 74. ERBEC 70 comprises electrical circuits and has functionality that is known in the regenerative braking art. ERBEC block 70 electrically communicates with AC motor/generators 22a, 22b, electrical shaping block 72 and with ESD 12. ERBEC block 70 includes electrical circuits that form the conventional regenerative braking system in a hybrid electric vehicle or an electric vehicle. Electrical shaping block 72 is disposed intermediate to, and in respective electrical communication with both on-vehicle transducer 20 and ERBEC block 70. Electrical signals between electrical shaping block 72 and ERBEC block 70 are carried on signal path 76. ERBEC block 70 and electrical shaping block 72 is also respectively in electrical communication with RF link block 74. RF link block 74 wirelessly receives/transmits data information with power transmitter 15. Electrical shaping block 72 serves to provide an electrical interface between on-vehicle transducer 20 and ERBEC block 70 of RBEC 26. Electrical shaping block 72 is needed when coupling arrangement 17 operates at a first frequency, or first range of frequencies and ERBEC block 70 operates at a second frequency, or second range of frequencies different from the first frequency so as to harmonize the first frequency of coupling arrangement with the operating second frequency of ERBEC 70. In many electrical applications the ERBEC operates in a range of frequencies that is in relation to tire rotational speed. Electrical shaping block 72 advantageously ensures that the electrical signal received from on-vehicle transducer 20 is transmitted through ERBEC block 70 is at the same frequency as the at least one AC motor/generators 22a, 22b. RF link block 74 collects data information about the operational characteristics of ECS 10 and ESD 12. These characteristics includes voltage of the ECS (V), electrical current of the ECS (I), a state of health of the ESD (SoH), and a state of charge (SoC) of ESD 12, and the ON/OFF operational state of the ECS. RF link block 74 wirelessly communicates this data information via wireless signal 84 to power transmitter 15 so that the ECS system efficiency is maintained at a desired rate to electrically charge ESD 12. Alternately, this data information may be utilized so that the ECS is not used to electrically charge the ESD or provide power from the ESD to the power grid. Power transmitter 15 may also send data on ECS 10 via wireless signal 82 to RF link 74. Alternately, the RF link block/power transmitter wireless communication may be used to relay power grid information, such as energy costs, such that the operator of the ECS may further control when the ECS assists to transmit the stored energy of the ESD to the power grid. Still alternately, the RF link block/power transmitter wireless communication may be used to program key codes to allow the ECS to be used for different vehicles other than the original vehicle that the ECS was intended for. For example, if an operator of the ECS purchases a power transmitter for home use and a friend of the operator brings his/her vehicle over and wants to electrically charge their vehicle, this information may be exchanged using the RF link block/power transmitter wireless communication to allow the friend's vehicle to be electrically charged.

ECS Operation Truth Table

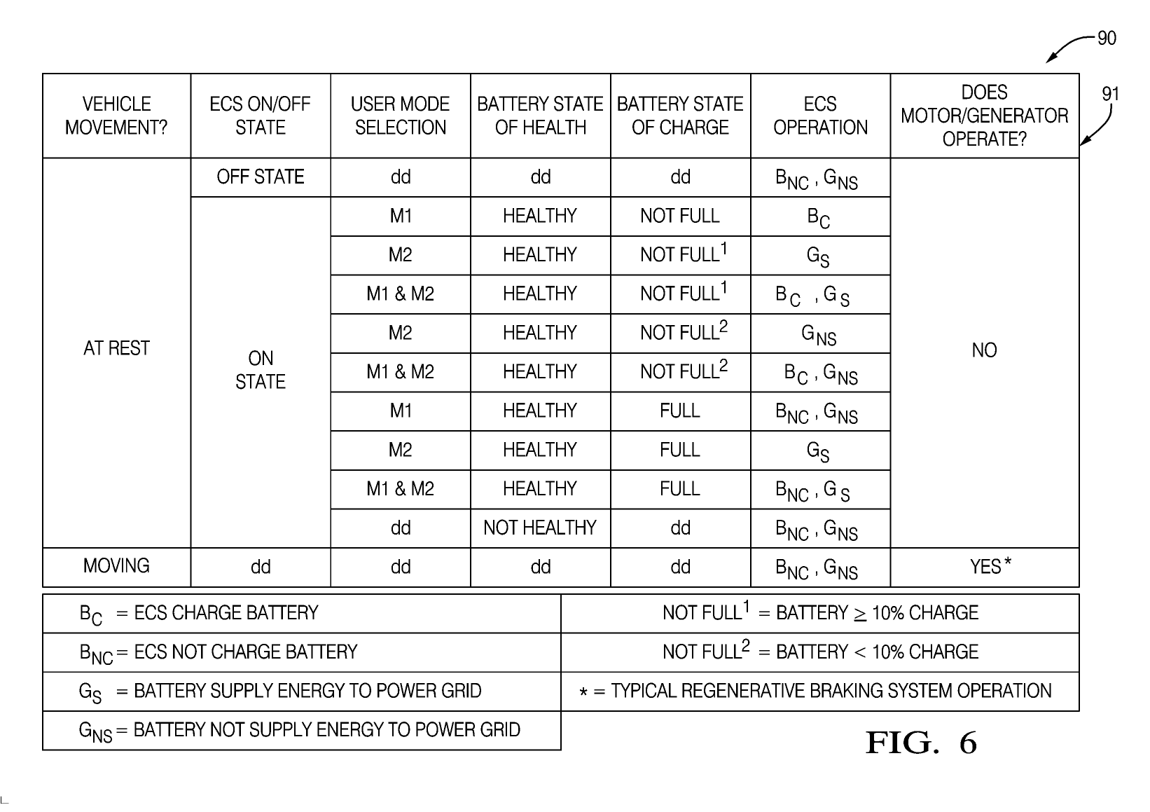

Referring to FIG. 6, an operation truth table 90 for ECS 10 is illustrated. The ECS system operating characteristics 91, going from the left to the right of the operation truth table, are defined and briefly described as follows. The designator “dd” in operation truth table 90 indicates that the value for the particular ECS system characteristic may have any possible value that is associated with the particular column of interest.

Vehicle movement?—This column indicates whether the vehicle is AT REST or in motion, or MOVING. Generally, when vehicle 16 is AT REST, ECS 10 is configured to operate in first mode of operation 1 or in second mode of operation 2. When vehicle 16 is MOVING along a road, ECS 10 is not operable. Rather, when MOVING along the road AC motor/generators 22a, 22b are configured to operate to electrically charge battery 12 or power the drivetrain of vehicle 16 as is typically operation for regenerative braking electrical circuit 26 as is known in the regenerative braking art.

ECS ON/OFF State—This denotes a conscious decision by operator 34 of ECS 10 to allow activation of ECS 10 for operation. ECS 10 may be placed in an ON STATE or an OFF STATE. For example, this may occur after operator 34 aligns vehicle 16 over off-vehicle transducer 18 and then depresses an on/off pushbutton disposed on power transmitter 15 which puts ECS 10 in the ON STATE. With the ECS 10 put in the ON STATE by operator 34, ECS 10 operation may then be governed by other characteristics as illustrated in operation truth table 90. The ECS may be put in the OFF state by using an off switch associated with the ECS, or depressing the on/off pushbutton a second time, or even be timed to automatically go into the OFF state after a predetermined time if the ESD is done being electrically charged or the ECS is no longer in use in either of the modes 1,2. Additionally, starting the ignition of the car may also put the vehicle into the OFF state. Yet alternately, the OFF state may be attained by any method or means that achieves this purpose.

User Mode Selection—ECS 10 may be put in first mode of operation 1 which is designated in operation truth table 90 as M1 or in second mode of operation 2 which is designated as M2. User mode selection is made by operator 34 independent of the ECS ON/OFF state. Selection of modes of operation 1, 2 are further described below under the heading “Selection Modes of ECS.”

Battery State of Health (SoH)—The designators in this column are HEALTHY or NOT HEALTHY for battery 12. A HEALTHY battery state provides indication that battery 12 is able to function and be charged by ECS 10 or AC motor/generators 22a, 22b or that battery 12 may supply energy to power grid 14. If battery 12 is NOT HEALTHY battery 12 is not able to function and be charged by ECS 10 or AC motor/generators 22a, 22b or that battery 12 may not supply energy to power grid 14. For example, a battery that is NOT HEALTHY may have developed an undesired quality defect and may be damaged in manner that does not allow battery 12 to receive or transmit electrical charge. The battery state of health may be determined by the vehicular battery management system. The vehicular battery management system may then transmit this data to the ECS.

Battery State of Charge (SoC)—This column provides an indication of a state of electrical charge that battery 12 contains and has designators in operation truth table 90 of FULL and NOT FULL. The FULL designator generally indicates that battery 12 is full of electrical charge so as to not be able to accept additional charge from ECS 10 or AC motor/generators 22a, 22b. The NOT FULL designator generally indicates that battery 12 is not full of electrical charge so as to be able to accept additional charge from ECS 10 or from AC motor/generators 22a, 22b. While the key of truth table 90 shows a break point of 10% of the total state of charge for the energy capacity of battery 12, this break point may be set at any desired level.

ECS Operation—This column provides indication how ECS 10 will operate in relation to the values in the row of interest of the other columns in operation truth table 90. The key as illustrated in FIG. 6, provides further description of the operation values of ECS 10.

Does motor/generator operate?—The designator for this column is either YES or NO. AC motor/generators 22a, 22b generally do not operate to electrically charge battery 12 when vehicle 16 is AT REST. AC motor/generators 22a, 22b are configured to operate to electrically charge battery 12 when vehicle 16 is MOVING per the “Vehicle Movement?” column previously described herein. Thus, AC motor/generators 22a, 22b are configured to operate when ECS 10 does not operate to electrically charge battery 12 or assist to provide stored energy of battery 12 to power grid 14.

Selection of Modes of ECS

ESC 10 operates either in first mode of operation 1 or in second mode of operation 2. First mode of operation 1 and the second mode of operation 2 are also respectively selectable by a data command received by ECS 10. Preferably, first mode of operation 1 and second mode of operation 2 are user-selectable by human operator 34 of ECS 10. Referring to FIG. 2, human operator 34 may wirelessly communicate the selection of modes 1, 2 by a portable cellular phone 35. For example, this may occur if the cellular phone wirelessly communicates a signal 37 to power transmitter 15 as best illustrated in FIG. 2. The electrical signal that contains the data command is received by an antenna 42 associated with power transmitter 15. Alternately, the human operator may select and communicate the data command with the ECS by using a PDA, personal computer, or any type of device configured to select and send out the data command to the ECS. Alternately, the data command may be sent to the vehicle such that the vehicle receives the data command relays the message to the ECS. Power transmitter 15 may further transmit this information to RF link 74 via signal 82. Alternately, such an electrical application may also include the data message being sent over a data communications bus in the vehicle that is in electrical communication with the ECS. The data communications bus may have a hard-wired data bus or be a wireless data bus.

Power grid 14 may be managed and operated by a power grid management municipality (not shown). In another embodiment, the ECS may also operate in either the first mode of operation or the second mode of operation based on a data command received by the ECS from a power grid management municipality. The data command from the power grid management municipality may be wirelessly communicated to the vehicle so that the vehicle communicates the data command information with the ECS. Still alternately, the data command from the power grid management municipality may occur directly with the ECS, such as with the power transmitter of the ECS. In yet another embodiment, the power grid management municipality may issue a data command that allows energy to be received by the power grid. The operation of the ESC in the first mode of operation or the second mode of operation then depends on the user-selectablity of the modes as previously described herein.

ECS 10 is not in use in first mode of operation 1 or second mode of operation 2 when vehicle 16 is movingly travelling down a road. When vehicle 16 is moving, the motor portion of AC motor/generator 22a, 22b electrically powers a drivetrain of vehicle 16 to move vehicle 16 down the road. When vehicle 16 is braked while traveling down the road, the generator portion of AC motor/generator 22a, 22b electrically charges the ESD 12. ECS 10 is also not in use when vehicle 16 is in a rest state and energy is not wirelessly being transmitted between first transducer 18 and second transducer 20 when ECS 10 is in either first mode of operation 1 or second mode of operation 2. For example, this operation condition may occur when vehicle 16, and hence second transducer 20 is not in proximity to first transducer 18 such that energy is not wireless transmitted therebetween.

ECS 10 is partially in operation if ECS 10 is ready to provide energy to power grid 14, but the power grid municipality has not authorized ECS 10 to provide energy to power grid 14. ECS 10 is also partially operational when the power grid municipality has authorized ECS 10 to provide energy to power grid 14 and ECS 10 is ready to provide energy to power grid 14, but human operator 34 of ECS 10 has not authorized second mode of operation 2 of ECS 10 to operate. ECS 10 is partially in operation if ECS 10 is ready to electrically charge ESD 12, but is prevented from doing so if ESD 12 is a full state of electrical charge.

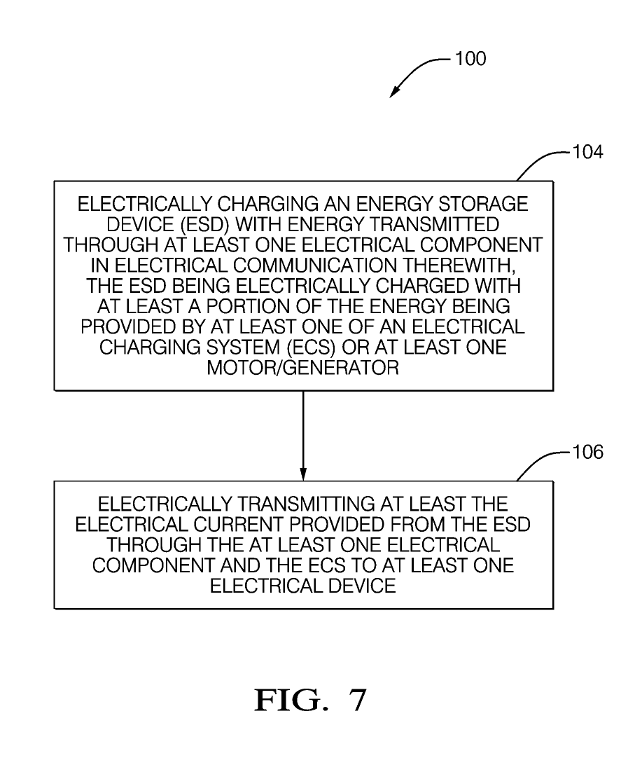

When vehicle 16 is in the rest state, referring to FIG. 7, ECS 10 is in use when energy is wirelessly transmitted between first transducer 18 and second transducer 20 and ECS 10 is disposed in the first mode of operation 1 which is step 104 of method 100 to electrically charge ESD 12. ECS 10 is also in use when energy is wireless transmitted from the ESD 12 through RBEC 26, second transducer 20 of ECS 10, first transducer of ECS 10 when ECS 10 is disposed in second mode of operation 2 which is step 106 of method 100. For example, method 100 may be operative in second mode of operation 2 when vehicle 16 is disposed so that second transducer 20 is in proximity to first transducer 18 and the power grid municipality has authorized ECS 10 to provide energy to power grid 14 and human operator of ECS 10 has also authorized operation of second mode of operation 2 of ECS 10, as been previously discussed herein.

A more complete understanding of the operation of ECS 10 when not in use, when partially in use, or when in use is best illustrated by reviewing FIG. 6.

The electrical charging system as described herein is better suited to electrically communicate with a regenerative braking system that operates using AC induction motor/generators. A regenerative braking system that operates on AC electrical parameters is set to receive energy having AC parameters from the generator or set to deliver energy from the battery having AC parameters. This feature may allow the ECS to be constructed with a lessor amount of electrical components. In contrast, if the regenerative braking system operates with DC drive motor/generators, the ECS may require additional electrical components to ensure the AC signal of the ECS is suitably handled by the regenerative braking system. In addition, the simplicity or complexity of the interface electronics that include the electrical shaping block and the RF link block may also be based on the frequency of the operation of the ECS and the frequency of operation of the regenerative braking system in an electrical application of interest. Some regenerative braking systems may operate at a frequency from 500 Hz to 10 kHz. The ECS may operate in a frequency range from 10 kHz to 450 kHz. When the operative frequency of the ECS for a given electrical application is closer to the operative frequency of the regenerative braking system, such as at 10 kHz, the electrical components of the interface electronics of the electrical shaping block and the RF link may have a decreased amount of electrical components that may allow manufacture of the ECS at less cost. In an alternate embodiment, the second transducer may be in direct electrical communication with the RBEC without the need to use an electrical shaping block. When the ECS and the existing regenerative braking electronics block operate at the same frequency or the same range of frequencies as previously discussed herein, the electrical shaping block may not be needed.

Alternately, the ECS may be formed of a power transmitter, the first transducer and the second transducer and/or the RF link block and/or the electrical shaping block in contrast to also including the RBEC and motor/generators as best illustrated in FIG. 4, and previously described herein. For example, the RBEC, especially the existing RBEC block and the motor/generators may be associated with the vehicular system in some electrical applications. When a vehicle manufacturer plans to use the ECS, the vehicle manufacturer may further modify the regenerative braking system or electrical circuit to at least include ports that allow electrical connection of the second transducer and/or the electrical shaping block and/or the RF link block, especially when any or all of these electrical transducers/blocks are disposed external to the regenerative braking system. In another alternate embodiment, a RBEC as discussed herein may substitution for, and replace the original regenerative braking electrical circuit, that for example includes the ports and/or the RF link block and/or the electrical shaping block. This interchangeability may be useful if the ECS is purchased by the operator of the vehicle after the vehicle purchase and the vehicle manufacturer has not made further modifications to the original regenerative braking electrical circuit to easy electrically couple to the ECS.

In another alternate embodiment, the electrical shaping block and the RF link block may be disposed external to the RBEC. In some electrical applications, the packaging requirements of the vehicle manufacturer may dictate that these electrical blocks be separate from the regenerative circuit electrical block.

Still alternately, the vehicle manufacturer may further construct the regenerative braking system to include ports and also include one or both of the electrical shaping block and the RF link block. In yet another alternate embodiment, the ECS may include the power transmitter, the first and the second transducer, the regenerative braking system that includes the existing RBEC block and the at least one motor/generator. Further alternate embodiments may include any or all of these electrical devices/blocks/components being installed after the vehicle is manufactured. For example, this may occur if the ECS is sold as an aftermarket product that is purchased by a consumer of the vehicle. In yet another alternate embodiment, the RF link block and/or the electrical shaping block may be disposed external to the vehicle.

Alternately, additional electronics/electrical components may be needed in the power transmitter to ensure bi-directionality of the electronic signal through the power convertor block depending on whether the ECS is in the first mode of operation or the second mode of operation. These electronics/electrical component may be in addition to the power converter block previously described herein.

In another alternate embodiment, the power transmitter may output electrical current when the ECS is in the second mode of operation to other electrical devices that further shape the electrical signal so that the electrical signal is in a form readily received by the power grid.

Alternately, the cellular phone may communicate mode status to other portions of the ECS or to the vehicle which then communicates the mode information to the ECS.

Thus, an ECS that electrically charges an ESD is also operative to provide the ESD's energy to a power grid disposed external to the vehicle has been presented. Advantageously, the ECS combines with an existing regenerative braking electrical circuits disposed on the vehicle to provide a bi-directional energy flow. First, the ECS electrically charges the battery through the RBEC. Second, the ECS assists to supply stored energy of the ESD through the RBEC to the power grid disposed external to the vehicle. Each of these features is utilized while the vehicle is in a rest position which further combines nicely with the generator portion of the motor generator charging the battery when the vehicle is in a braking maneuver when movingly travelling on a road. If the energy coupling arrangement of the ECS operates at a similar frequency to that of the existing electronics of the regenerative braking system, the on-vehicle transducer may be directly electrically coupled to the regenerative braking electrical circuit without additional electrical signal shaping electronics. A data message sent from a power grid municipality may allow the first mode of operation, the second mode of operation or the first and second mode of operation of the ECS to be enabled. This data message may be electrically communicated and received by the vehicle and electrically communicated directly to the ECS. User-selectability of the first and the second mode of operation may further enhance the operational flexibility of the ECS. In some situations, for example, the user may not want the second mode of operation to occur even through the power grid municipality has indicated that it would be allowable to do so. The human operator, or user may make user-selectable mode selections for the ECS by cellular phone, PDA, personal computer, and the like.

While this invention has been described in terms of the preferred embodiment thereof, it is not intended to be so limited, but rather only to the extent set forth in the claims that follow.

It will be readily understood by those persons skilled in the art that the present invention is susceptible of broad utility and application. Many embodiments and adaptations of the present invention other than those described above, as well as many variations, modifications and equivalent arrangements, will be apparent from or reasonably suggested by the present invention and the foregoing description, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the following claims and the equivalents thereof.

We claim:

1. A method to electrically charge an energy storage device (ESD), comprising:
electrically charging the ESD with energy transmitted through at least one electrical component in electrical communication therewith, said ESD being electrically charged by at least a portion of said energy being provided by,
(i) an electrical charging system (ECS), and
(ii) at least one motor/generator,
in which said ECS and said at least one motor/generator, respectively, are in electrical communication with said at least one electrical component.

2. The method according to claim 1, wherein said at least one electrical component comprises a regenerative braking electrical circuit (RBEC) disposed in a vehicle.

3. The method according to claim 2, wherein the ECS includes a first transducer and a second transducer that wirelessly receives energy from the first transducer, and the second transducer is in electrical communication with the RBEC.

4. The method according to claim 1, wherein the ECS is in electrical communication with at least one electrical device, and the method further includes,
electrically transmitting at least electrical current provided from the ESD through the at least one electrical component and the ECS to said at least one electrical device.

5. The method according to claim 4, wherein said at least one electrical device comprises a power grid and said at least one motor/generator is an AC motor/generator.

6. The method according to claim 1, wherein the step of electrically charging the ESD includes the ECS having a first mode of operation and a second mode of operation, and the method further includes,
electrically charging the ESD with the ECS when the ECS is in the first mode of operation, and
electrically charging at least one electrical device with energy transmitted through the at least one electrical component and the ECS that is supplied by the ESD when the ECS is in the second mode of operation,
wherein when the ECS operates in the first mode of operation the ECS does not operate in the second mode of operation.

7. The method according to claim 6, wherein at least one of,
(i) the first mode of operation, and
(ii) the second mode of operation
is selectable by a data command received by the ECS.

8. The method according to claim 6, wherein the first mode of operation and the second mode of operation, respectively, are user-selectable by a human operator of the ECS.

9. An electrical charging system (ECS) for charging an energy storage device (ESD) disposed on a vehicle, comprising:
a first transducer configured to receive energy from a power source;
a second transducer configured to receive at least a portion of said received energy wirelessly transmitted from the first transducer;
at least one motor/generator configured to capture kinetic energy from at least one wheel of the vehicle; and
at least one electrical component that receives at least one of,
(i) energy from the second transducer, and
(ii) at least a portion of said kinetic energy from said at least one motor/generator
to electrically charge the ESD.

10. The ECS according to claim 9, wherein said at least one electrical component comprises a regenerative braking electrical circuit (RBEC) disposed on said vehicle.

11. The ECS according to claim 10, wherein the second transducer is in direct electrical communication with the RBEC.

12. The ECS according to claim 10, wherein the ECS further includes,
a power transmitter,
an electrical shaping block, and
a RF link block,
wherein the electrical shaping block is in respective electrical communication with, and intermediate to said second transducer and an existing regenerative breaking electrical circuit (ERBEC), and the RF link block wirelessly transmits data information associated with the ESD to the power transmitter.

13. The ECS according to claim 9, wherein the ECS comprises a first mode of operation and a second mode of operation, and
said first mode of operation of the ECS includes the second transducer wirelessly receiving said energy for the first transducer to electrically charge the ESD to produce an electrical current that is transmitted through the at least one electrical component to electrically charge the ESD, and
said second mode of operation of the ECS includes the first transducer wirelessly receiving energy from the second transducer as received from the at least one electrical component transmitted thereto by the ESD so that the ECS provides an electrical current to the at least one electrical device disposed external to the vehicle.

14. The ECS according to claim 13, wherein the at least one electrical device comprises a power grid.

15. The ECS according to claim 13, wherein the first mode of operation and the second mode of operation, respectively, operate when the vehicle is in a rest state and the at least one motor/generator is configured to electrically charge the ESD when the vehicle is in a moving state that is different from the rest state.

16. The ECS according to claim 13, wherein the first mode of operation and the second mode of operation are selectably controlled by the ECS.

17. The ECS according to claim 13, wherein ECS operation is controlled by at least one of,
(i) user selection of the ECS in at least one of the first mode of operation and the second mode of operation, and at least one of,
(a) a state of electrical charge of the ESD,
(b) a state of health of the ESD, and
(c) an on/off state of the ECS.

18. The ECS according to claim 13, wherein electrical charging of the ESD is based on,
(i) user selection of the ECS in at least one of the first mode of operation and the second mode of operation, and
(ii) a state of electrical charge of the ESD, and
(iii) a state of health of the ESD, and
(iv) an on/off state of the ECS.

19. The ECS according to claim 13, wherein the ECS operates in at least one of,
(i) the first mode of operation, and
(ii) the second mode of operation
based on a data communication message received by the ECS from a power grid management municipality.

20. The ECS according to claim 9, wherein the vehicle comprises one of,
(i) a hybrid vehicle, and
(ii) a hybrid electric vehicle.
